(19) United States
(12) Patent Application Publication
(10) Pub. No.: US 2015/0048756 A1
(43) Pub. Date: Feb. 19, 2015

(54) LAMP UNIT POWER SUPPLY SYSTEM

(71) Applicant: TRIDONIC UK LTD, Chineham Basingstoke (GB)

(72) Inventor: Ian Wilson, East Herrington (GB)

(73) Assignee: TRIDONIC UK LTD, Chineham Basingstoke (GB)

(21) Appl. No.: 14/385,847

(22) PCT Filed: Mar. 19, 2013
(86) PCT No.: PCT/EP2013/055654

§ 371 Date: Sep. 17, 2014

(30) Foreign Application Priority Data
Mar. 19, 2012 (GB) 1204787.4

(51) Int. Cl. H05B 41/295; H02J 9/06; H05B 33/08

(52) U.S. Cl. CPC H05B 41/295; H05B 33/0815; H02J 9/065
USPC 315/291

(57) ABSTRACT

A power supply system supplies gas discharge lamp unit (5) arc power and cathode power. The system includes an emergency driver (17) for receiving power from a power supply (15). The driver provides the lamp arc power and the cathode power. The driver adjusts the total power provided to the lamp unit and varies the proportion of the total power provided as the arc power and as the cathode power in order to provide optimised arc power and cathode power according to the circumstances.

### TECHNICAL FIELD

The present invention relates to a power supply system for supplying lamp unit power, and to a power supply method for supplying lamp unit power.

### BACKGROUND TO THE INVENTION

Various arrangements for lighting systems are known which provide both conventional and emergency lighting. Such emergency lighting is intended to be activated when the conventional lighting is no longer operative because the direct mains supply to the conventional lighting is no longer available or malfunctions. Emergency lighting is typically powered by a battery or other energy storage device. Conventional lighting is controlled by an on/off switch by means of which a user (or control system) can control whether the lighting is illuminated or not. Generally, emergency lighting is intended to be automatically illuminated when the absence of mains power or the malfunction of mains power for the conventional lighting is detected in some way. Emergency lighting may be used to allow escape from buildings that would otherwise be in darkness due to the inoperativeness of the conventional lighting.

Emergency lighting and conventional lighting may share components. For example, the same lamp (such as a gas discharge lamp or light emitting diode) may be used for both conventional and emergency lighting. Other components may also be shared.

A lighting system comprising emergency lighting and conventional lighting may be considered to have two operating modes. In a normal mode, when the direct mains supply is operating normally (within the normal voltage range), a switched mains input, controlled by an on/off switch, is monitored, and the lamp is illuminated or extinguished in dependence upon the switched mains input. In an emergency mode, when the mains supply is not available or is malfunctioning (is outside the normal voltage range), the lamp is illuminated automatically, irrespective of the status of the switched mains input, using power from a battery or other storage element.

FIG. 1 shows schematically the elements of a lighting arrangement that provides both a normal mode and an emergency lighting mode. A mains AC supply 1 provides power in the normal mode to a mains ballast 3 optimised for use with the mains supply 1. The mains ballast 3 drives the lamp 5 when a mains relay 7 is closed. A control circuit (not shown) monitors the mains AC supply 1. If the control circuit detects that the mains AC supply is interrupted, or if it is determined to be malfunctioning (operating outside an acceptable range of values), the control circuit may provide an appropriate signal to relay control line 9 to open the mains relay 7 and to close an emergency relay 11. The emergency relay 11 allows the lamp 5 to be driven in an emergency mode.

To provide the emergency mode, the emergency lighting arrangement includes, in addition to the mains relay 7, relay control line 9 and emergency relay 11, a battery charger 13, a battery 15 and an emergency driver 17.

When the mains AC supply 1 is operating normally (and the lamp 5 is powered by the mains ballast 3), the battery 15 is charged (continuously or when required) by the battery charger 13. The battery charger 13 provides galvanic isolation between the AC mains supply 1 and the battery 15. When the control circuit detects that the AC supply 1 is interrupted (or malfunctioning), the emergency relay 11 is closed (the mains relay 7 is opened), and the emergency driver 17 illuminates the lamp 5 using power from the battery 15. Emergency driver 17 provides galvanic isolation of the battery 15 from the lamp 5.

As will be known to those skilled in the art, gas discharge lamps, such as fluorescent lamps, require an arc voltage to be applied between the lamp electrodes by a lamp arc supply. For most gas discharge lamps the lamp cathodes are heated by a cathode supply in order to heat the cathode filaments to cause them to emit electrodes into the gas within the lamp tube by thermionic emission.

Known emergency lighting arrangements do not provide an effective way of controlling lamp power for optimum lamp operation.

Known emergency lighting arrangements do not provide an effective way of controlling the battery discharge for optimum battery operation.

### SUMMARY OF THE INVENTION

In one aspect, the present invention provides a power supply system for supplying lamp unit power, the system including a driver for receiving power from a power supply and operable to provide the lamp power from the power supply, characterised in that the driver is operable to adjust the total power provided to the lamp unit from the power supply.

The driver can vary the proportion of current drawn from the battery. The driver can also adjust the total power provided to the lamp unit from the power supply and optionally can adjust the power provided as the arc power and as the cathode power.

The lighting system may be an emergency lighting system. The power supply may be a battery or other charge storage device.

The lamp unit may comprise one or more lamps, such as light emitting diodes (LED) or gas discharge lamps, e.g. fluorescent lamps.

In another aspect, the present the invention provides a power supply system for supplying a lamp unit, the system including a driver for receiving power from a battery as power supply and operable to provide the lamp power from the power supply, characterised in that the driver is operable to adjust the total power provided to the lamp unit from the power supply and to adjust the current drawn from the battery at the optimum level despite the changes to the characteristics of the battery or alternation of the lamp unit characteristics.

The driver may adjust the current or power drawn from the battery at the optimum level despite the changes to the characteristics of the battery or alternation of the lamp unit characteristics.

The driver may adjust a first parameter to set the ratio of arc power to cathode power supplied, and then may adjust a second (different) parameter to set the total power provided to the lamp unit whilst maintaining the set ratio. The first parameter may be the frequency of operation of at least one switch of the driver and the second parameter may be the duty cycle of at least one switch of the driver, the or each switch controlling application of power from the power supply to the lamp.

The driver may include an input part and an output part. Preferably, the input part and the output part are galvanically isolated.

The output part may include a plurality of circuits, each having a different frequency response, and wherein the input part is operable to supply the output part at a selected frequency to provide a desired proportion of the arc power to the cathode power. Because the circuits have different frequency responses the proportion of the power supply current in the respective circuits is different at different frequencies. The embodiment to be described allows a desired proportion of the available power to be provided as arc power and as cathode power by selecting an appropriate frequency at which the frequency responses are such that the respective proportions of power for the arc power and the cathode power exist. The battery current at the selected frequency may, however, not be at a desired level and, in the embodiment, the battery current may be reduced in order to adjust the total power provided to the lamp unit. The circuits may be multiple-order circuits. The circuits may be second order circuits, such as L and C series and L series and C parallel circuits.

The output part may be formed by passive components only. The output part may comprise a filter stage and a rectifier. The input part can be operable to supply the output part at a selected frequency or pulse width to provide a desired amount of the lamp power or to adjust the amount of current or power drawn from the battery.

The input part may include pulse width modulation means operable to adjust the total power provided to the lamp unit, and thereby enable an optimal current to be drawn from the power supply, which is controllable independently of the frequency selection.

The driver may comprise a push-pull converter, such as a DC-AC push-pull inverter, a flyback converter, a boost converter or another type of switched converter.

The system may be operable to maintain a desired level of arc power and a desired level of cathode power when a quality or quantity of the lamp(s) when a lamp unit is changed. For example, a lamp may be changed for a lamp with different characteristics, or a further lamp may be added to the lamp unit. This may be done by a user after installation of the system.

The system may be operable to maintain a desired level of lamp power when the power supply is altered. For example, a battery may be replaced, or an additional cell may be added. This may be done by a user after installation of the system.

The present invention also provides an emergency lighting arrangement including the power supply system as defined above, which may further include the power supply mentioned above.

The present invention also provides a power supply method as defined in the claims.

The present invention also a power supply method for supplying lamp unit power, wherein a driver receives power from a power supply to provide the lamp power from the power supply, characterised in that the driver is operable to maintain a desired level of total power provided to the lamp unit from the power supply when a quantity or quality of the lamp(s) in the lamp unit is changed or when the power supply is altered.

In one embodiment to be described a power control method uses pulse width modulation (PWM) in the form of dead time or duty cycle control in order to obtain the correct current or power levels drawn from a battery set in order to power a lamp at the output of an emergency converter for driving the lamp from a battery set. A step-up inverter supplies high frequency rectangular symmetric waveform to the output with galvanic isolation. The converter used may be an inverting flyback type. Other output circuit arrangements are possible. Other modulation methods can be applied as well.

The system allows the addition of another battery as a means of improving lamp power in emergency mode. PWM can be applied for regulating the total output power, adapting the emergency system to the extra battery. If the battery is changed, for example by adding additional cells (or replacing the battery with a different battery), or in any other way, this may alter the nominal current. In response to this, the switch duty cycle may be adjusted so that the current drawn from the battery is at the optimum level despite the changes to the characteristics of the battery.

In one embodiment to be described a power control method uses pulse width modulation (PWM) in the form of dead time or duty cycle control and frequency modulation (FM) in order to obtain the correct power levels for lamp arc and cathodes in the output of an emergency converter for driving fluorescent lamps from a battery set. A step-up inverter supplies high frequency rectangular symmetric waveform to the output with galvanic isolation. The converter used may be an inverting dc-ac push-pull type. The output comprises three second order circuits: one L series and C parallel for the arc; two equal L and C series for the cathodes. Other output circuit arrangements are possible.

If the respective output circuit arrangements for the lamp arc and lamp cathodes have a different frequency response, in principle frequency modulation can be used to select a frequency at which the response of the respective output circuits provides a desired proportion of power to the lamp arc and a desired proportion of power to the lamp cathode. However, at the frequency which provides the desired frequency response, the current drawn from the battery set may not be the optimum current. PWM allows the optimum current to be drawn at any selected frequency.

For example, if only applying frequency modulation/control, the need for a multi-lamp compatible system together with the fixed frequency response of the two filter types leads to a non-optimised power ratio in some loads cases. PWM can be applied to add another degree of freedom in the power regulation, enabling optimised arc and cathodes supply. Once the frequency for achieving the right arc to cathodes power ratio is set, PWM can regulate the right level of total output power, which yields in an optimised power in the lamp. In the embodiment, power regulation consists of setting a certain value of average battery discharge current.

The system allows the addition of another battery as a means of improving only lamp arc power in emergency mode. Such feature is not realisable, however, applying only FM. Again, FM can set the optimum power ratio and PWM can be applied for regulating the total output power, adapting the emergency system to the extra battery.

The embodiment to be described illustrates how to implement a system and method able to supply the correct arc and cathode power for all lamp cases in the most optimised way. Further, the embodiment allows the possible addition of an extra battery for improving only the arc power instead of transferring the extra power with similar arc-cathode ratio to the load. Battery count reduction is also enabled by applying such regulation technique.

One possible implementation of the system and method of the embodiment for optimising the regulation of power levels delivered to the lamp arc and cathodes in emergency mode may be the following:
1. Enables the correct power supply levels for the lamp arc and cathodes in fluorescent lamp ballasts supplied from a battery set.
2. Enables the correct power supply levels for the lamp arc and cathodes in fluorescent lamp emergency unit in emergency mode of operation.
3. Provides a possibility of adjusting the lamp arc and cathode power other than frequency modulation without changing the circuit in a fluorescent lamp emergency unit.
4. In case of multi-lamp supply using the same emergency unit, optimises the power supplied to the fluorescent lamp arc and cathodes for each particular input voltage and load case (lamp type).
5. In case of adding a battery (or batteries) to the set of a fluorescent lamp emergency unit, enables the transfer the power available from that addition in emergency mode only to the arc, improving ballast lumens factor (BLF).
6. In case of reducing a battery (or batteries) from the battery set, of a fluorescent lamp emergency unit, enables the setting of the most optimised power level in the lamp arc and cathodes in emergency mode (in this case, often increasing power in the cathodes and reducing in the lamp).
7. Enables the adjustment of the output power levels (lamp arc and cathodes) of a fluorescent emergency unit in production through a calibration procedure.
8. The above features can be limited to the lamp power in case where a light emitting diode is used as lamp load (no cathode heating).

The embodiment provides power regulation/control in the lamp (e.g. fluorescent lamp arc and cathodes), independently of the lamp type and battery set voltage. As it may not be possible to set proper power levels for multi-lamp and multi-battery applying only FM due to filters and lamps characteristics, the use of PWM adds another degree of freedom, enabling the required regulation.

As some embodiments describe a fluorescent lamp driver it has to be stated such system is only one example described for better understanding and the invention may be used for other kinds of lamp drivers such as light emitting diodes as well. The arc power correlates to the lamp power which is the light generating power.

### BRIEF DESCRIPTION OF THE DRAWINGS

For a better understanding of the present invention an embodiment will now be described by way of example, with reference to the accompanying drawings, in which:

FIG. 1 shows schematically the elements of a lighting arrangement that provides both a normal mode and an emergency lighting mode;

FIG. 2 shows schematically an emergency driver in accordance with an embodiment of the invention;

FIG. 3 shows an emergency driver circuit connected to a lamp and a battery in accordance with an embodiment of the invention;

FIG. 4 shows the rectangular alternating output voltage produced by the input part of the emergency driver circuit of FIG. 3, the vertical axis showing the voltage and the horizontal axis showing time;

FIG. 5 shows fluorescent lamp arc current response across frequency, the vertical axis showing current in amps and horizontal axis showing frequency in Hertz;

FIG. 6 shows lamp cathode current response across frequency, the vertical axis showing current in amps and the horizontal axis showing frequency in Hertz;

FIG. 7 shows fluorescent lamp arc and cathode current response across frequency, the vertical axis showing current in amps and the horizontal axis showing frequency in Hertz;

FIG. 8 shows fluorescent lamp arc power response, cathode power response and the total power across frequency, the vertical axis showing power in watts and the horizontal axis showing frequency in Hertz;

FIG. 9 shows the total power response across frequency, the vertical axis showing power in watts and the horizontal axis showing frequency in Hertz;

FIG. 10 shows battery current frequency response for the lamp arc, cathode and total supply power, the vertical axis being current in amps and the horizontal axis being frequency in Hertz;

FIG. 11 shows battery current due to cathode and arc power reflecting frequency response at a 100% duty cycle and a reduced duty cycle, the vertical axis being current in amps and the horizontal axis being frequency in Hertz; and

FIG. 12 shows battery current due to cathode and arc power reflecting frequency response at a 100% duty cycle and a reduced duty cycle, the vertical axis being current in amps and the horizontal axis being frequency in Hertz.

In the drawings generally like elements are designated with the same reference sign.

### DETAILED DESCRIPTION OF EMBODIMENT OF THE INVENTION

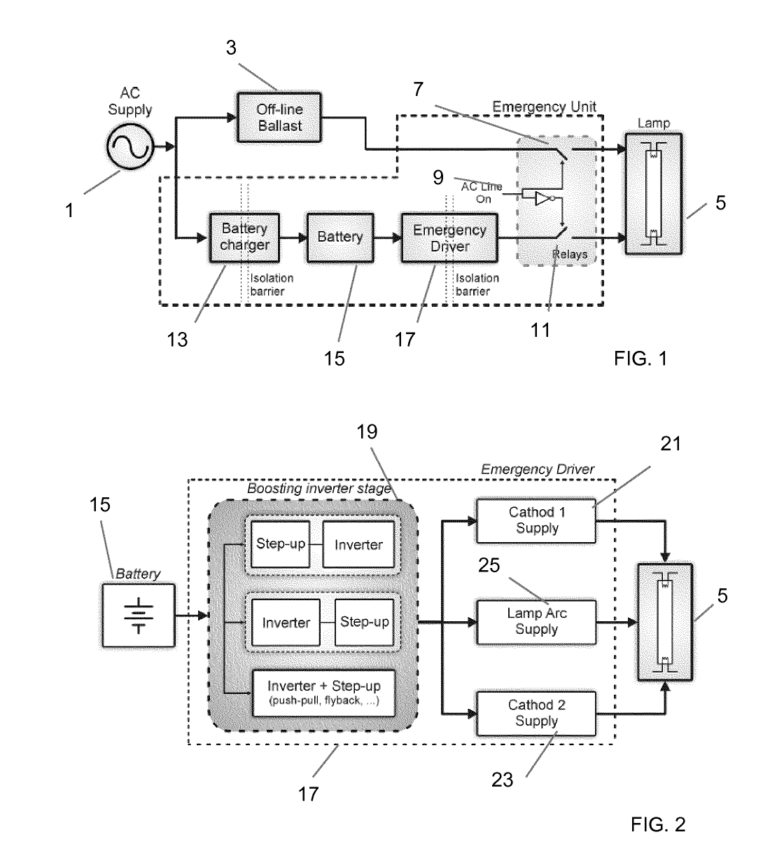

As briefly discussed above, the lighting arrangement shown in FIG. 1 includes a control unit (not shown) which detects when the AC mains supply 1 is present and operating correctly—such as when the AC mains supply 1 presents a voltage higher than a certain threshold (187 volts in a 230 volt nominal supply, for example). When the AC mains supply 1 is present and operating correctly, the mains ballast 3 provides power to illuminate the lamp via closed relay 7. Power from the AC mains supply 1 is also provided to battery charger 13 to charge the battery 15 (or to keep the battery 15 fully charged). The battery 15 may comprise a plurality of cells. Another energy storage device may be used instead of the battery 15.

When the control unit detects that the AC mains supply 1 is interrupted or malfunctioning—such as when the mains AC supply 1 presents a voltage lower than a certain threshold (145 volts in a 230 volt nominal supply, for example) the control unit opens the mains relay 7, closes the emergency relay 11, and activates the emergency driver 17. Emergency driver 17 provides power to illuminate the lamp 5 from only the battery 15 via the closed emergency relay 11. Isolation is provided from the AC mains line 1 to the battery 15 for safety reasons. The lamp 5 may be a gas discharge lamp or a light emitting diode (LED).

An emergency driver 17 in accordance with an embodiment of the invention is shown in FIG. 2. The emergency driver 17 may comprise a boosting converter stage 19, e.g. a push-pull converter with a step-up characteristic, whose input is connected directly to the battery 15. The boosting converter stage 19 may be also comprised by a combination of a push-pull converter followed by a step-up converter, e.g. a boost converter, or a combination of a step-up converter followed by a push-pull converter.

The emergency driver 17 may provide a first cathode supply 21 and a second cathode supply 23 to heat the cathode filaments in case where the lamp 5 is a fluorescent lamp and a lamp arc supply 25. In case of a light emitting diode as lamp 5 there may be only a lamp supply 25. The lamp supply 25 may be a single stage converter as e.g. a flyback converter which takes over the function of the boosting converter stage 19.

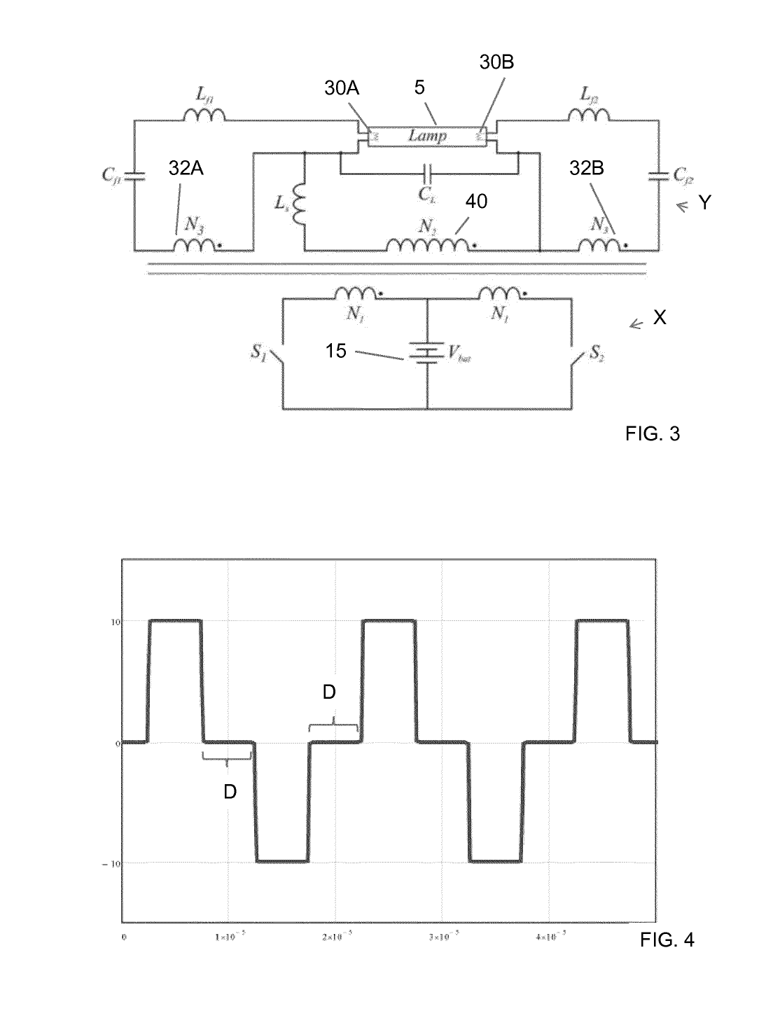

FIG. 3 shows one example of the emergency driver 17 circuit connected to the lamp 5 and battery 15.

The emergency driver 17 comprises an input part X in the form of a bi-directional push-pull inverter. The input part X includes identical first and second portions connected in parallel across the battery 15. Each of the portions comprises a switch S₁/S₂ and a primary winding section N₁. By alternate operation of the switches S₁/S₂, the input part produces a rectangular alternating output voltage, as shown in FIG. 4. The output may include a “dead time” D when both the switches S₁ and S₂ are closed, when the output is at zero volts. The duty cycle of the switches determines the duration of the dead time. The time for which each of the switches is closed and the frequency of operation (opening/closing) of the switches is controlled by a driver controller (not shown).

The input part X of the emergency driver 17 supplies an output part Y. The respective lamp cathodes 30A and 30B are supplied via the two identical secondary windings N₃ of the push-pull inverter of the output part Y with LC series identical filters connected to them. The first cathode 30A is connected to the first secondary winding 32A via series connected capacitor C_{f1} and inductor L_{f1}. The second cathode 30B is connected to a second secondary winding 32B via a series connected second capacitor C_{f2} and inductor L_{f2}.

The lamp arc supply is provided by another secondary winding 40 of the push-pull inverter through a L series C parallel filter, comprising inductor Lₛ (connected in series between the secondary winding 40 and the first cathode 30A) and capacitor C_{L} (connected in parallel across the first cathode 30A and the second cathode 30B).

A voltage is applied to the lamp filters with a magnitude proportional to the battery voltageand the turns ratio, as described by equation (1).

$${V}_{Q} = \frac{{N}_{S}}{{N}_{P}} \cdot {U}_{Batt} \qquad ( 1 )$$

where N_{P} and N_{S} are the primary and secondary turns number and U_{Batt} is the battery 17 voltage.

The primary turns number is the same for both arc and cathodes supply (N₁ in FIG. 3). The secondary turns number is the same for both of the two cathodes (N₃ in FIG. 3) and different for the arc supply (N₂ in FIG. 3).

The rectangular waveform shown in FIG. 4 is composed of the sum of its first and its odd harmonics, changing harmonics amplitudes according to its duty cycle. Such voltage is applied to the set filters and loads (arc and cathodes).

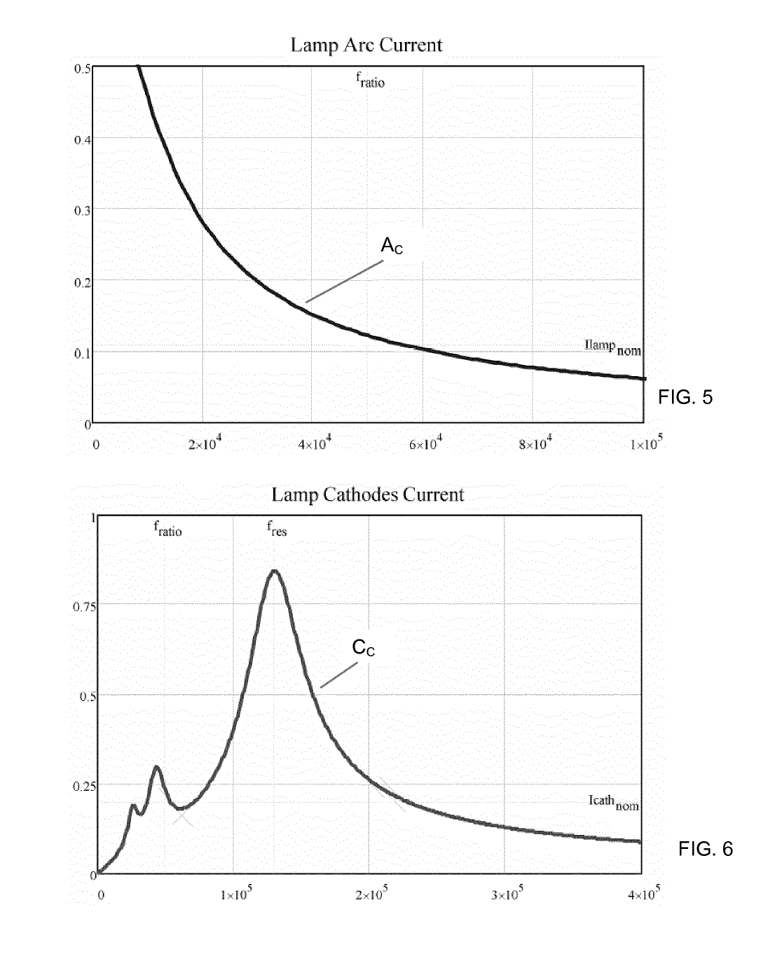

For a given lamp, the typical frequency response of the lamp arc current A_{C} for a certain L series C parallel filter (Lₛ and C_{L}), considering the lamp as an equivalent resistance R_{L} (fixed), is shown in FIG. 5. The plot is based on the response of equation (2).

$${I}_{RL} ( s ) = \frac{\frac{1}{L \cdot C}}{{s}^{2} + s \cdot \frac{{R}_{L}}{L} + \frac{1}{L \cdot C}} \qquad ( 2 )$$

Where L is the inductance
C is the capacitance
s is the frequency

For a given lamp, the typical frequency response of the cathode current C_{c} for a certain LC series filter (L_{f1}, and C_{f1}, or L_{f2} and C_{f2}) and a certain cathode resistance R_{cath} supplied with a rectangular waveform is shown in FIG. 6, whose plot is based on equation (3).

$${I}_{Cath} ( s ) = \frac{\frac{{V}_{IN}}{L} \cdot s}{{s}^{2} + s \cdot \frac{{R}_{Cath}}{L} + \frac{1}{L \cdot C}} \qquad ( 3 )$$

Where L is the inductance
C is the capacitance
s is the frequency
V_{IN} is the voltage

The response of FIG. 6 includes the effect of the rectangular waveform (FIG. 4) harmonics. It can be seen that, due to the filter characteristic and amplitude of harmonics, the 3^{rd} and the 5^{th} harmonic are considerable in the range from 20 kHz up to 50 kHz.

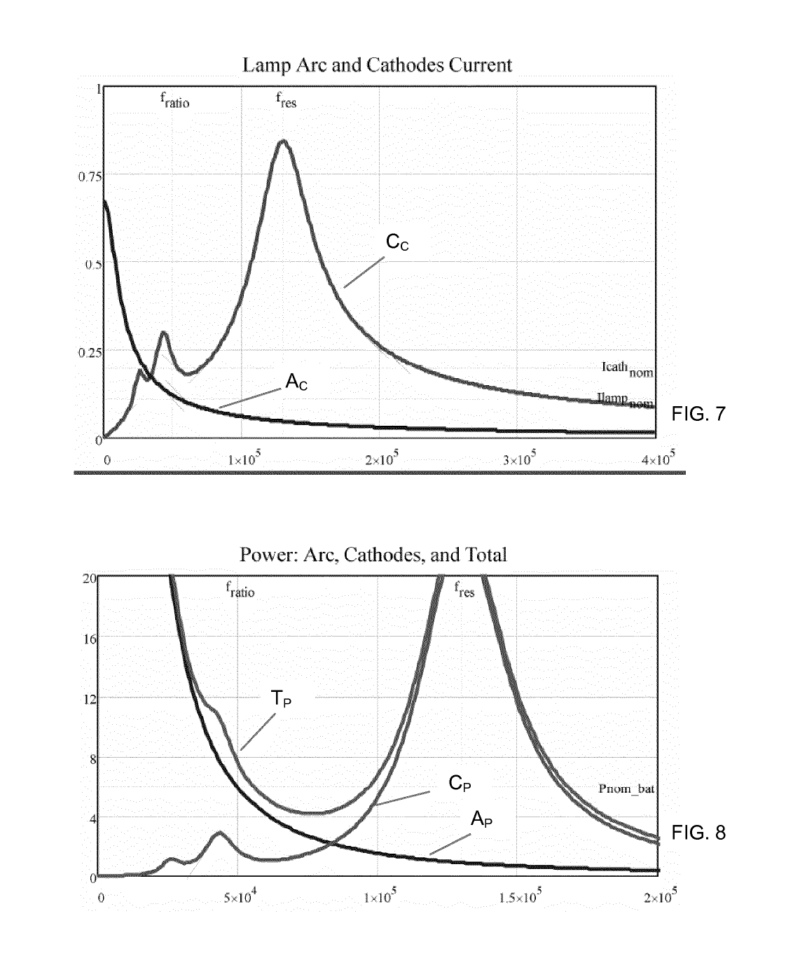

FIG. 7 shows both responses from FIGS. 5 and 6 in the same plot for comparison.

As an objective is to regulate the power, FIG. 8 illustrates the power response of the lamp arc Aₚ and cathodes Cₚ, which are derived directly from the resistance and current from equations (2) and (3) (power=current²×resistance), and also shows the total power Tₚ.

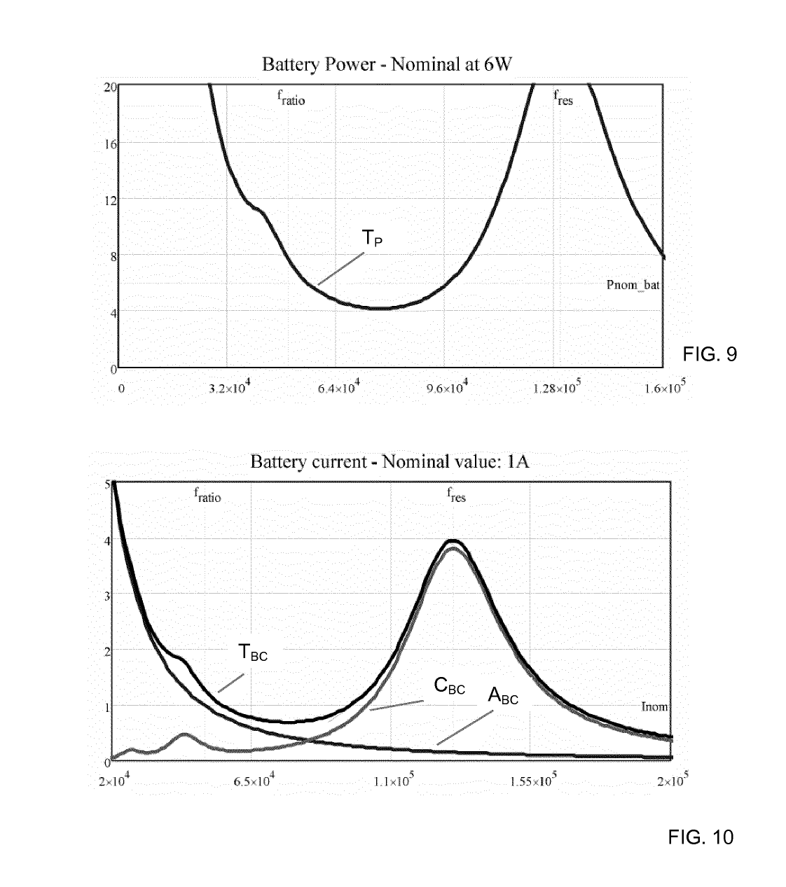

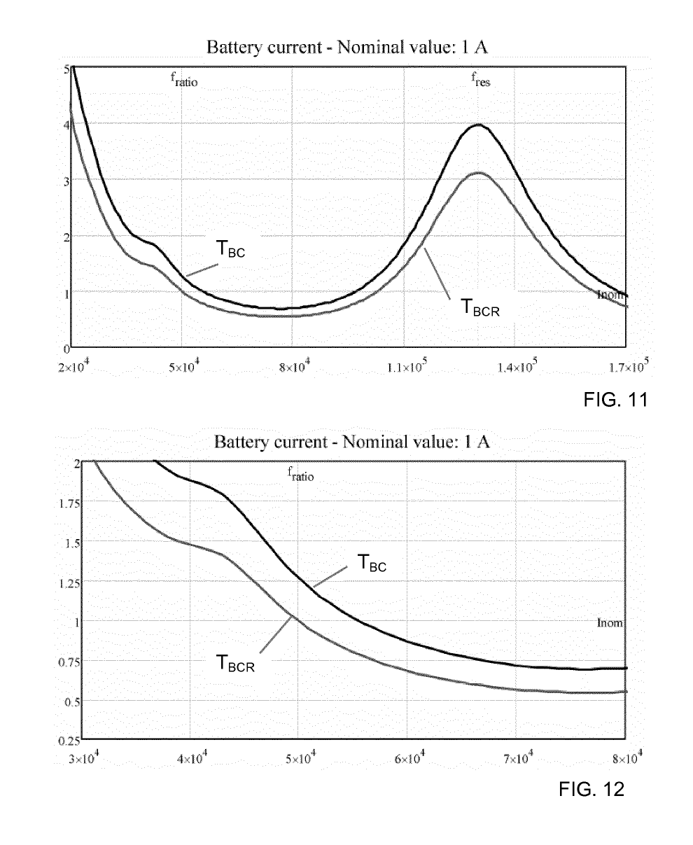

FIG. 9 shows again the total power Tₚ supplied from the battery 15 (neglecting converter efficiency) across a range of frequencies for the emergency converter. As the battery 15 is a DC voltage source, its average current is exactly equal to the power divided by its voltage. Thus, the current reflects the total output power plus losses in the converter in this embodiment. FIGS. 10 and 11 show the battery current for a 6.0V battery as an example, ignoring converter efficiency. FIG. 10 shows the battery currents due to power in the cathodes C_{BC} power in the arc A_{BC} and the total power T_{BC}, the sum of the cathode and arc power. Those battery current responses are of interest for detailed analysis as an objective of the emergency converter of FIG. 3 is to regulate the current in the battery for regulating power. The current T_{BC} due to the total power is also shown in FIGS. 11 and 12.

As can be seen in the plots of FIG. 10, a change in the converter switching frequency yields in a change in the power ratio between arc and cathodes. Setting the appropriate switching frequency (fᵣₐₜᵢₒ) is a first step for achieving optimum power regulation.

At first, based on the current and power responses and particular characteristic of a certain lamp, the fᵣₐₜᵢₒ frequency (50 kHz in this example) is chosen as it offers the required power ratio between lamp arc and cathodes. All plots (in FIGS. 6 to 12) present fᵣₐₜᵢₒ for illustrating this example. The switches S, and S₂ are therefore operated at the frequency fᵣₐₜᵢₒ.

However, in this example, the total power is too high for the battery nominal current of 1 A. The power for fᵣₐₜᵢₒ yields in approximately 1.25 A in the battery (see FIGS. 10 to 12), which is 25% higher than the nominal.

As the ratio between arc and cathodes power is correct at fᵣₐₜᵢₒ, the total power is regulated independently of that. In this example, that is realised by reducing the duty cycle of the converter. This is done by reducing the duty cycle of both of the switches S, and S₂ so that the dead time is increased. In this example, the duty cycle is reduced to 80% to provide the desired current of 1 A.

FIGS. 11 and 12 show the battery current responses for 100% duty cycle (T_{BC})—where the dead time is zero or negligible—and for a reduced (80%) value of duty cycle T_{BCR}. It can be observed that a reduction of duty cycle brings the battery current down and the 1 A nominal battery discharge current is reached at the fᵣₐₜᵢₒ optimized switching frequency, resulting in the most optimized power supply for lamp arc and cathodes.

If the battery is changed, for example by adding additional cells (or replacing the battery with a different battery), or in any other way, this may alter the nominal current. In response to this, the switch duty cycle may be adjusted so that the current drawn from the battery is at the optimum level despite the changes to the characteristics of the battery. Further, if the characteristics of the battery are changed, this may alter the optimum proportion of power that is provided to the lamp (e.g. to the lamp arc and the lamp cathodes). If a cell is added, typically, the power applied to the lamp (e.g. arc and cathodes) should remain the same (increasing the power applied to the cathodes would just generate heat and increasing the power used for light would just lead to increased light output). The embodiment allows the proportion of power provided to the lamp cathodes and the lamp arc to be adjusted by selecting an appropriate frequency of the operation of the switches of the emergency converter. This allows to extend the time where power can provided by the additional cell to be applied to the lamp, and thereby resulting in increased time of illumination in emergency mode, rather than being used for higher light output. This could also allow additional power provided by the additional cell to be applied to the lamp arc, and thereby resulting in increased illumination, rather than being wasted by producing heat. It also allows to keep the current or power drawn from the battery constant independent of the number or type of battery and also independent of the type of lamp connected. In case of a light emitting diode as a lamp it is sufficient to control the power provided to the lamp as no cathode heating is necessary. In case of such LED lamp the current or power drawn from the battery can be adjusted to a fixed value irrespective of the lamp load or battery load.

If the nature of the lamp unit is changed, the embodiment allows the altered lamp unit to be driven in an optimal way. For example, if an additional fluorescent bulb or light emitting diode is added to the lamp unit, this could increase the total current drawn from the battery. Adjusting the duty cycle of the switches S1 and S2 allows the optimal nominal current drawn from the battery to be maintained despite the alternation of the lamp unit characteristics.

The system may control the current or power drawn from the battery set. It may be important that the current drawn from the battery (which is the battery discharge current) remains constant in order to extend the overall battery life time and to extend the time where the battery can supply the lamp in an emergency mode. As the battery voltage is almost constant for most of the discharge period it may be also possible to control the power drawn from the battery as this power control will lead to an almost constant current for most of the discharge period.

For simplifying the explanation, harmonics changes with duty cycle are not included in this example, although they may become significant in the design.

Although the embodiment uses a push-pull converter, several converter arrangements are able to provide a suitable higher rectangular voltage output, such as a simple cascade of a boost converter and an inverter. All drivers where pulse modulation, e.g. pulse width modulation, and frequency modulation can be applied may be used in accordance with the invention.

1. A power supply system for supplying a lamp unit, the system comprising a driver for receiving power from a battery as power supply and operable to provide the lamp power from the power supply, wherein the driver is operable to adjust the total power provided to the lamp unit from the power supply and to adjust current drawn from the battery at the optimum level despite changes to the characteristics of the battery or alternation of the lamp unit characteristics.

2. A power supply system for supplying gas discharge lamp unit arc power and cathode power, the system comprising a driver for receiving power from a power supply and operable to provide the lamp arc power and the cathode power from the power supply, wherein the driver is operable to adjust the total power provided to the lamp unit from the power supply and to vary a proportion thereof provided as the arc power and as the cathode power.

3. The system of claim 1, wherein the driver includes an input part and an output part.

4. The system of claim 3, wherein the output part includes a plurality of circuits, each having a different frequency response, and wherein the input part is operable to supply the output part at a selected frequency to provide a desired proportion of the arc power to the cathode power.

5. The system of claim 3, wherein the input part includes pulse width modulation means operable to control at least one switch to adjust the total power provided to the lamp unit from the power supply.

6. The system of claim 1, wherein the driver comprises a push-pull converter.

7. The system of claim 2, wherein the driver is operable to maintain a desired level of arc power and a desired level of the cathode power when a quantity or quality of the lamp(s) in the lamp unit is changed.

8. The system of claim 1, wherein the driver is operable to maintain a desired level of the arc power and a desired level of the cathode power when the power supply is altered.

9. The system of claim 1, wherein the power supply comprises a battery.

10. A power supply system for supplying a lamp unit with power, the system comprising a driver for receiving power from a battery as power supply and operable to provide the lamp power from the power supply, wherein the driver is operable to maintain a desired level of total power provided to the lamp unit from the power supply when a quantity or quality of the lamp(s) in the lamp unit is changed or when the power supply is altered.

11. An emergency lighting arrangement comprising the power supply system of claim 1.

12. The emergency lighting arrangement of claim 11, comprising the power supply.

13. A power supply method for supplying lamp unit power, comprising
using a driver to receive power from a power supply to provide the lamp power from the power supply, and:
operating the driver to maintain a desired level of total power provided to the lamp unit from the power supply when a quantity or quality of the lamp(s) in the lamp unit is changed or when the power supply is altered.

14. A power supply method for supplying gas discharge lamp unit arc power and cathode power, comprising:
using a driver to receive power from a power supply to provide the lamp arc power and the cathode power from the power supply, and
using the driver to adjust the total power provided to the lamp unit from the power supply and to vary the proportion thereof provided as the arc power and as the cathode power.

15. The power supply method of claim 14, wherein the driver adjusts a first parameter to set the ratio of arc power to cathode power supplied, and then adjusts a second parameter to set the total power provided to the lamp unit whilst maintaining the set ratio.

16. The method of claim 13, wherein the driver includes an input part and an output part.

17. The method of claim 16, wherein the output part includes a plurality of circuits, each having a different frequency response, and wherein the input part supplies the output part at a selected frequency to provide a desired proportion of the arc power to the cathode power.

18. The method of claim 16, wherein the input part uses pulse width modulation to control at least one switch to adjust the total power provided to the lamp unit from the power supply.

19. The method of claim 13, wherein the driver comprises a push-pull converter.

20. The method of claim 13, wherein the driver maintains a desired level of arc power and desired level of the cathode power when a quantity or quality of the lamp(s) in the lamp unit is changed.

21. The method of claim 13, wherein the driver maintains a desired level of the arc power and a desired level of the cathode power when the power supply is altered.

22. The method of claim 13, wherein the power supply comprises a battery.
